(19) United States
(12) Patent Application Publication
(10) Pub. No.: US 2016/0379527 A1
(43) Pub. Date: Dec. 29, 2016

(54) SKC-JJU256 ENCRYPTION USING KNIGHTS TOUR SOLUTIONS AS THE MAIN KEY TO CREATE A CRYPTOSYSTEM

(71) Applicant: Josiah Johnson Umezurike, Minneapolis, MN (US)

(72) Inventor: Josiah Johnson Umezurike, Minneapolis, MN (US)

(21) Appl. No.: 13/364,339

(22) Filed: Feb. 2, 2012

(51) Int. Cl. G09C 1/00

(52) U.S. Cl. CPC G09C 1/00; H04L 9/0618

(57) ABSTRACT

The solutions of open knight's tours identified in the Galois's Field (Gf) are used to encrypt any volume of data. The solution meaning all moves of the Knight's Tour which continues to link the next active node bringing about a Knight's Tour Solution within any specified scope of GF elements. A Knight which is a piece on the standard chess board moves 2 squares up or down and 1 square sideways or vice-versa: These moves alone validate an open Knight's tour. We noticed that the numbers derived from the solution of the Knight's tours are cryptographically secure. The permutation of filling up 4*8 grid or squares with any 26 input have upper bounds in the order 1039—with repetition of any 6 inputs. Relatively, the arrangements of known 128 inputs (ASCII) in 8*16 grid or squares present increased upper bounds. The embodiment uses the Knight's Tour Solutions to create a cipher.

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### CROSS-REFERENCE TO RELATED APPLICATIONS

This application makes new claims with nothing similar and nothing in close semblance for the purpose of non-provisional patent sought.

### FEDERALLY SPONSORED RESEARCH

not applicable.

### SEQUENCE LISTING OF PROGRAM

not applicable.

### SPECIFICATIONS

### Field

This application relates to Cryptography (Information Security) and the Knight's Tour solution there in yields a subsidiary of a major notation; the major of the application (Knight's Tour Solutions) will find uses in Cryptosystem; Photonic Chip Designs; other Circuit Designs.

### Background

There has never been a time when information security is need but now. AES block cipher is the state of Cryptosystem in the world. Today, there is a successful quasi-practical attack (Biclique Cryptanalysis of the full AES—Aug. 11, 2011) on it. However a priori-theoretical weakness is present I noted that it is possible to break into AES with the speed observed in the advancement of the present day technology. AES works in chunks or blocks so does its main keys. AES carries its operation in 9 rounds. The claim [8] shows all the rounds of AES. Upon coding one will have to code frameworks to cover those rounds. And that will offset the runtime process. One more thing, Bruce Schneier mentioned the lousiness of the S-Box on his blog dated back to Jul. 30, 2009.

SKC-JJ256 is a hybrid of stream cipher and characterized block cipher. The key neither depends on the plaintext nor the cipher text the block size could depend on the key. The key (D) is not equal to the plaintext as in OTP. It is not OTP or PNRG but it could meet the specifications independently. It is very misleading to see the main specification as the former. One can make the key (D) into periods in key (K) as shown in [71 as it is highly recommended. The RijnDael Block cipher independently specifies block size and key size from 128, 192 and 256 bits as well as eXCIPHER. You must note that Xecipher has no such limit which AES is characterized. I elected to use GF elements of 16*8 and/or increased unit squares (16*16) to represent and repeat some of the ASCII characters. You can disregard the unwritten characters 0-31 (32 characters). I concentrated on the written characters 32-127. It is also possible to include extended ASCII characters which range from 128-255. All representations are done in the standard form or state. There is no suggestion of any limitation to the possibilities when represented in this manner.

The ASCII written and/or unwritten characters are represented in an order or sequence called standard state (ST). The numbers on the standard state are superscripted with columns and rows identified in subscript. The solution derived from Knight's Tour of valid Knight's moves, is represented in a sequence called Knight's Tour Template (KT). All solved Knight's tour solution are potential main keys. There is no prior usage of (KT) in this manner for encryption. The main key is then processed in [1] to yield a cipher. Here we are stopping on the fifth round giving the scope of the elements chosen (4 by 8 square grids): In the special case of GF the elements host or represent an equivalent of 2⁸ bits of data.

(ST−ₘₐₚ−nKT=M₁)(mod n)//n=number of KT in this case a n=1

(KT*M₁=M₂)(mod n)//In array you code KT*=M₁ is assigned to M₂

(M₁*M₂=M₃)(mod n)

(KT*M₃=M₄)(mod n)

(M₃*M₄=M₅)(mod n)

What is seen below is an encryption and decryption process with CT2 or M2 as the Cipher.

### DETAILED DESCRIPTION OF THE EMBODIMENT

The embodiment now will be described more fully hereinafter with reference to the accompanying drawings, in which some examples of states of the embodiments are shown. Indeed, these embodiments may be embodied in many different forms and should not be construed as limited to the embodiment set forth herein; rather, these embodiments are provided by way of example so that this disclosure will satisfy applicable legal requirements. Like numbers refer to like elements throughout. Other details of the embodiment are found in the manual called eXCIPHER. The aforementioned manual holds some record of complexity requiring differentiation by colors. Red, blue, green, yellow, purple, baby blue and brown are used. The manual is separate within the format of this application but holds valid for finer details in examiners best interest.

Proceeding with the standard state (ST). The written and unwritten characters of any given language are first arranged in their known order following the four sides presented in the scope of the chosen Galois Field elements. This simply means that you can align the Standard state horizontally or vertically from each of the four corners as follows (emphasis are levied on the columns and rows(c,r):

You can equally initialize the standard state by starting from any position (c,r) you like on the grid or square units. The order will have to be maintained all through the process. The main point here is to show the complexity, subtleties and elements of a surprising nature within embodiment.
1. The characters in the standard state are mapped to numbers in the Knight's tour solution by selecting numbers matching the ones shown as the superscript of characters. This initializes key expansion.
2. The alphabets are rearranged using the Knight's tour solution around en grid thereafter. This specific Knight's tour solution is the first key in the cryptosystem.
3. The by-product of #2 is eXCIPHER Template 1 or CT1: This could be used as the final grid obtained. Plaintexts are then reformed within the context of this particular grid. This simply means that I use the final character grid obtained from the initial key expansion to establish the plaintext.
4. Some of the some of the characters in the cipher (CT1) are repeated following an expanded key of possibly same length as the plaintext: This is the second, key expansion.
5. The extended key-K (key (D) of periods i.e the key chosen by the parties using the cryptosystem) is mapped to numbers using the character or alphabet grid.
6. The extended key-K of numbers is added to the plaintext numbers (K eXOR M) and I find the remainder of the modulus operation. ‘M’ will denote message to be encrypted [7]: in the special case above mod 32 is used and this is third key expansion.
7. The numbers obtained from the operation on 6 are mapped back to characters using the character or alphabet grid. This yields Cipher texts. See FIG. 2.0 and FIG. 3.0 for encryption and decryption process.
8. Somehow this is repeated to form multiple rounds see [BACKGROUND]: Thereby, increases security.

To bring about further complication you can equally do a multiple addition of the eXCIPHER TEMPLATE 1 (CT1) against Knight's Tour Solution Template (KT) to yield CT2. The product of CT1 and CT3 can then be used to form another plaintext as in #3: A defused text elements.

### BRIEF DESCRIPTION OF THE DRAWING

The patent or application file contains at least one drawing executed in color. Copies of this patent or patent application publication with color drawing(s) will be provided by the Office upon request and payment of the necessary fee.

Having thus described the embodiment in general terms, reference will now be made to the accompanying drawings, which are not necessarily drawn to scale, and wherein:

FIG. 1 shows a 2-D block diagram of CIPHER templates ST, KT, M1, M2, M3, M4 and M5 according to one part (states) of the embodiment.

FIG. 2 is another 2-D diagram illustrating a number of steps of the encryption method according to one part (state) of the embodiment.

FIG. 3 is yet another 2-D diagram illustrating a number of steps of the decryption method according to one part (state) of the embodiment.

FIG. 4A-4G shows a 2-D diagram with structural details of all five (5) Cipher templates: M1, M2, M3, M4 and M5. The ST and KT are clearly identified FIG. 1a and FIG. 1b. The darkened squares are used to show a connection of one such position to another (transposition).

FIG. 5 shows a 2-D diagram with directions for initializing the ST within the noted four corners in any given elemental scope of GF. See DETAILED DESCRIPTION OF THE EMBODIMENT.

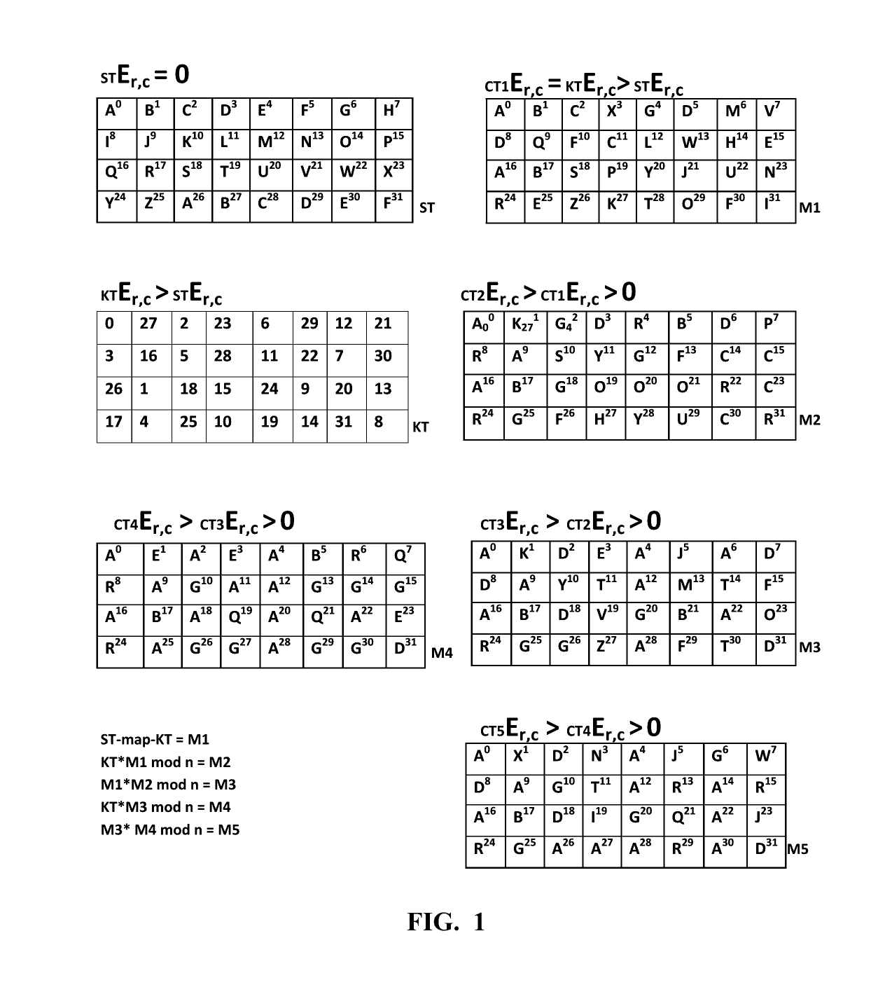

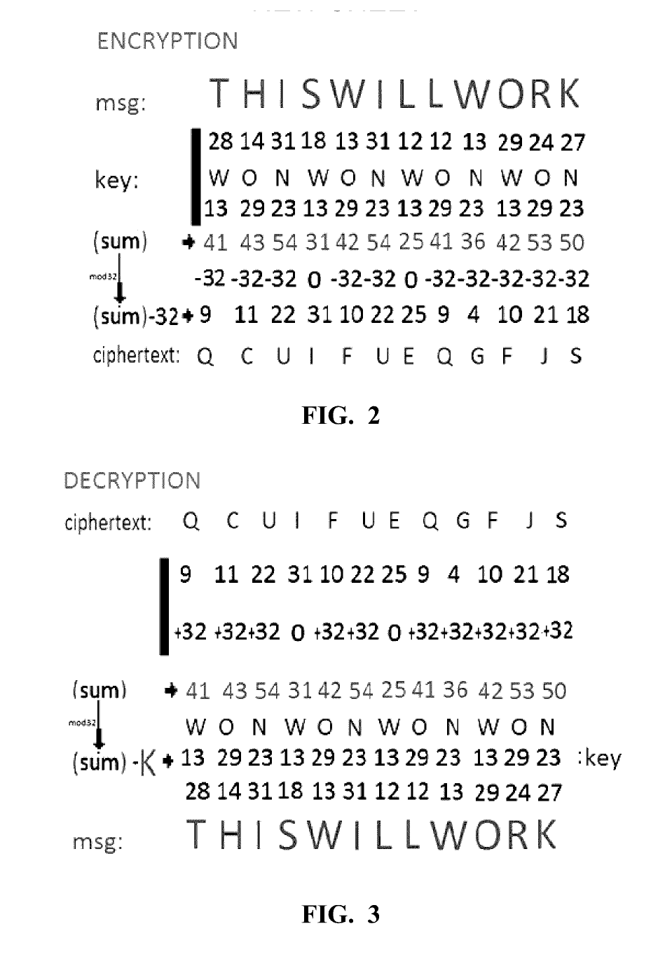

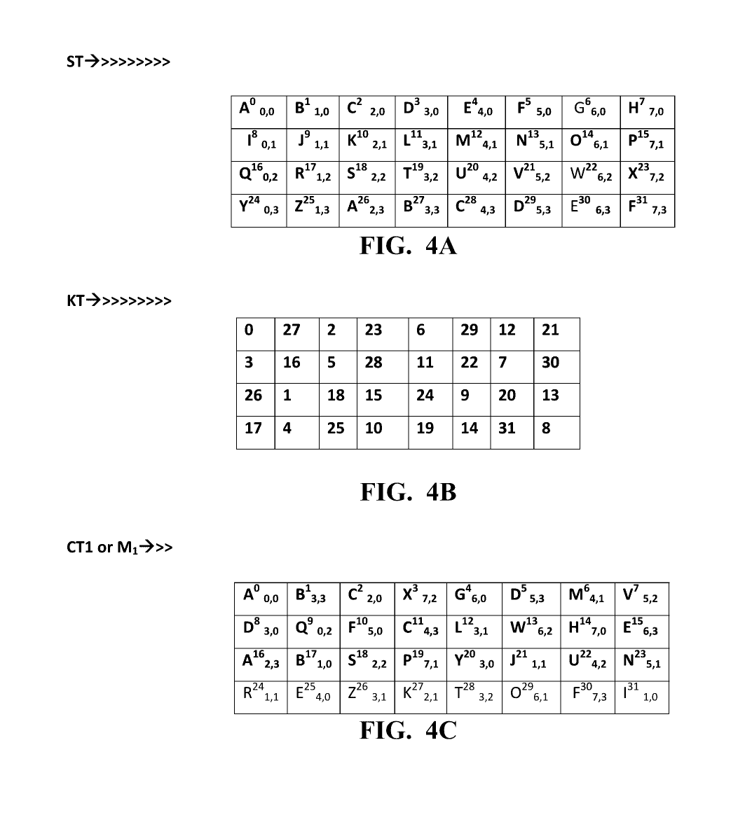

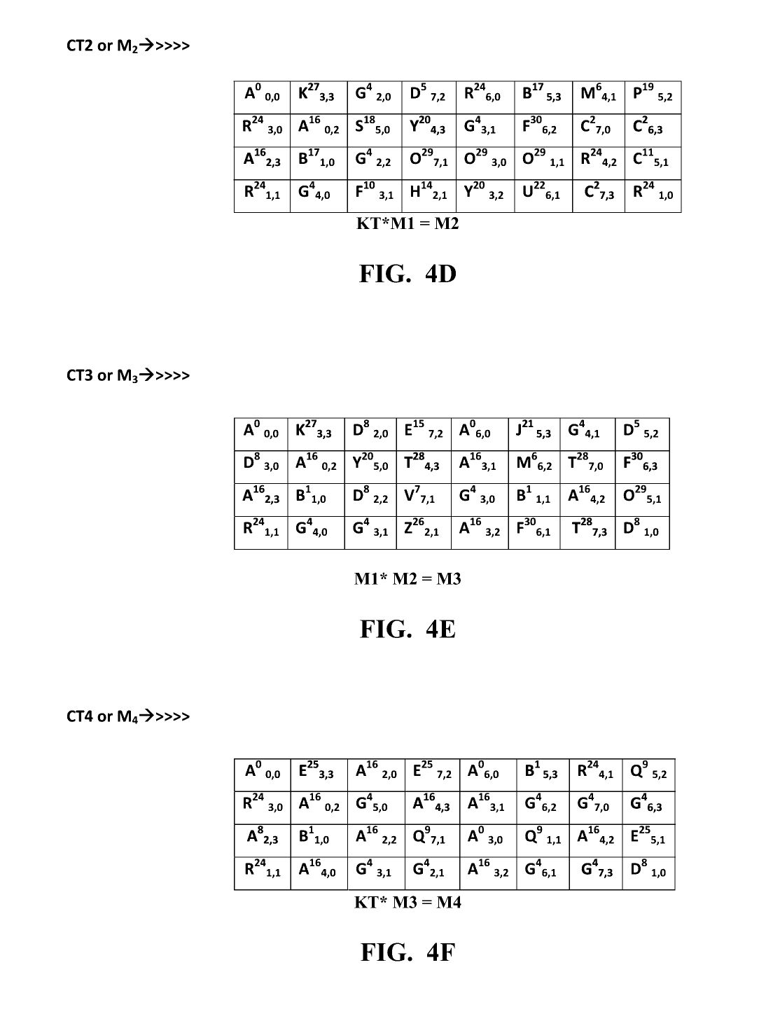

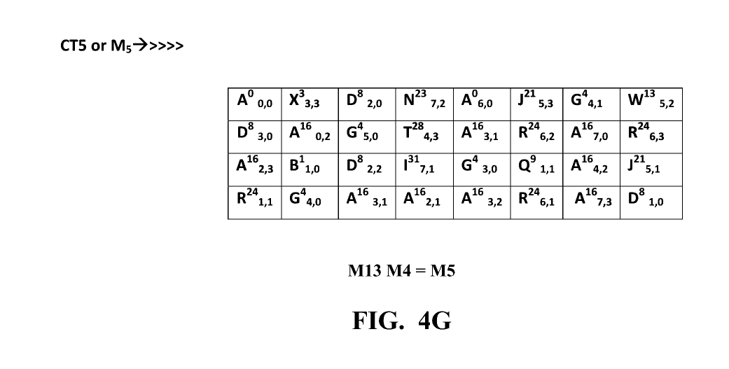

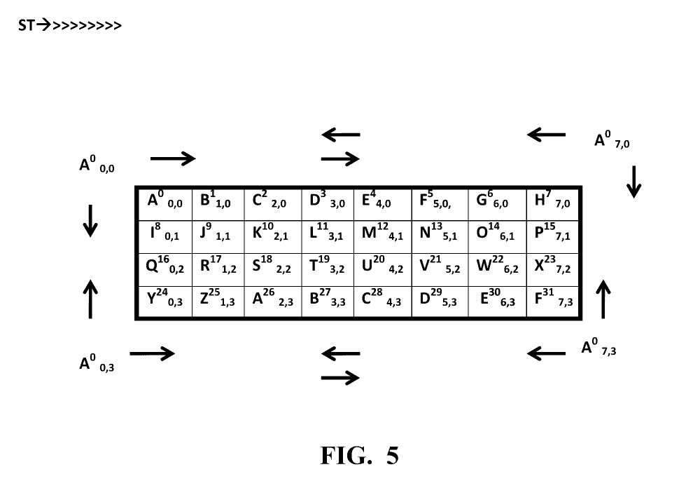

### SUMMARY OF THE EMBODIMENT

The embodiment subtly brings together two or more parallel ends of its seeming genre. This makes it the first of its kind to do so. The embodiment aims to solve some known problems in cryptography. It is recognized that corporations and businesses spend much (time, effort and money) to hide main keys and algorithms. [In the claim [9],] I espouse staging the security of new generation of ciphers on the entropy of the cryptosystem as opposed to making specific states of the embodiment a secret Some of the known attacks in crypto-analysis are packaged as:

1. Differential attacks
2. Linear attacks
3. Saturation attacks (square attacks)
4. Side channel attacks
5. Biclique attacks

The embodiment will ‘teach away’ on ways to advance the status-quo. All operations are performed in modular arithmetic as the example shows in number 6 of the [DETAILED DESCRIPTION OF THE EMBODIMENT].

The embodiment will set a race in the quest for a new generation of ciphers. It encompasses all other embodiments which escape my dull sense momentarily: The bulk of my work lies as ripe and all other ideas could be ambitious but trite in this vein for the purpose of the grant sought.

The mapped characters produce another template called ‘eXCipher’ text template 1 (CT 1).

A multiple addition of KT and CT1 produces CT2.

A multiple addition of CT1 and CT2 produces CT3.

A multiple addition of KT and CT3 further produces CT4.

A multiple addition of CT3 and CT4 produces CT5.

The final cipher CT5 can be used to produce a cipher text from any plain text with respect to a key shared between the two users in this cryptosystem.

### C=V(C(i])=V(MP])+V(K[i])

D=short key
K=longer key derived from D of periods

Clearly, it is a symmetric key arrangement with many odd inheritances. It can equally be used as CSPRNG, Hashing and as OTP. The hashing qualities are owed to a compression mechanism when thoroughly analyzed as the manual explains.

I do claim that when SKC-JJU256 is compared and contrasted to RijnDael (AES) the rounds following the current state of RijnDael are accomplished just by one move in the Knight's tour solution.

RijnDael (AES), with rounds are as follows:

Round(State,RoundKey)
{
ByteSub(State);
ShiftRow(State);
MixColumn(State);
AddRoundKey(State,RoundKey);
}

The final round of the cipher is slightly different. It is defined by:

FinalRound(State,RoundKey)
{
ByteSub(State) ;
ShiftRow(State) ;
AddRoundKey(State,RoundKey);

What is seen by the observer is a subtle transposition and substitution (transformation). The ideal cipher for SKC-JJU256 is unlimited as there are valid Knight's tours in the GF. One can never bring about all possible solutions of the Knight's tour; this fact is the strength to the system developed. I surmise that SKC-JJU256 is fit for incorporation in the computing of today and tomorrow given precedence to the entropy of the cipher, thus encrypted data as opposed to the secrecy of the main key and algorithm in general. This emerging technology is faster and will continue in such progression. Therefore, a cryptosystem of varied flavor is born as it is needed.

The ultimate claim is in recognition of the fact that multitude of ideas resonates and abounds within the knight's tour solution. The idea could be employed in photonic chip designs and Chip designs especially logic gate doping, etching and lithography. Amongst all, the commonality is that all numbers generated by Knight's Tour Solution are most definite and random; yet cryptographically secure for the purpose of Pseudo Random Number Generation (CSPRNG). All numbers following this algorithm [1] have just been noticed to appear in GF with definite randomness which makes it impossible for one to ignore these arrangements in many design areas.

Generally, an extra defense is what I present against any known attack. I claim that the promise of numerous flavors presents ample opportunities in commercializing the product (SKC-JJU256). There are functionalities to this system absent presently known advantages and least possible limitations. You will find all references in the concluding page of the manual—eXCIPHER found in [DETAILED DESCRIPTION OF THE embodiment].

It is so claimed that a ‘Matyorshka doll’ ensemble of the ciphers exist in the following order: M1, M2, M3, M4 and M5 for 26 inputs in GF of 32 elements. They are ciphers with dependency on KT. After the assignment in [2] it follows that to encrypt or decrypt you will use ST, Mn_1 and Mn. It is impossible to crack any level of the cipher if KT is unknown. There is no known limitation to the number of inputs and any given scope of GF.

The claim portent the use of these parts of embodiment displayed [DIAGRAM SECTION] as an engine of transposition, substitution and transformation of characters: Diagram of Cipher Templates details the shifting of rows, mixing of column and addition of round/s features.

The claim identifies these parts of the embodiment displayed in the diagram section as one of the ways to visualize the mechanics of the eXCIPHER as it manipulates inputs going through it. One can manually follow this approach for higher understanding of the process involved in order to encrypt and decrypt [BACKGROUND] using the embodiment. It is so claimed that the diagrams are indispensable part of this claim and complements all the claims made.

I extensively claim a Hybrid Functionality for SKC-JJU256: It embraces the better of the symmetric key ciphers: Bock cipher and Stream cipher as priori-art methods. It could also be used for OTP and PRNG. In theory OTP is known to be secure and unbreakable.

1. A standard state of written and/or unwritten characters is formulated to be mapped to the Knight's Tour Solution of numbers or Knight's tour template (KT) derived from the algorithm exhibited by a Knight on a standard chess board.

2.-15. (canceled)
